(19) United States
(12) Patent Application Publication
(10) Pub. No.: US 2002/0157027 A1
(43) Pub. Date: Oct. 24, 2002

(54) Method and system for providing a trusted boot source in a partition

(75) Inventors: Richard Alan Dayan, Wake Forest, NC (US); Joseph Wayne Freeman, Raleigh, NC (US); William Fred Keown JR., Raleigh, NC (US); Randall Scott Springfield, Chapel Hill, NC (US)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 09/841,150

(22) Filed: Apr. 24, 2001

(51) Int. Cl. H04L 9/32

(52) U.S. Cl. 713/202

(57) ABSTRACT

A method and system for providing a trusted boot source in a computer system is disclosed. The computer system includes an operating system and a partition that is nonviewable from the operating system. The method and system include allowing a plurality of sub-partitions to be defined in the partition. The plurality of sub-partitions corresponds to a plurality of boot sources. The method and system also include allowing a password to be provided for each of the plurality of sub-partitions. The password is required for a user to utilize a corresponding sub-partition as a boot source.

### FIELD OF THE INVENTION

The present invention relates to computer systems, and more particularly to a method and system for providing trusted boot sources in a partition.

### BACKGROUND OF THE INVENTION

FIG. 1 depicts portions of a conventional computer system 10. The conventional computer system 10 includes an operating system 12 and a hardfile 30. The hardfile 30 includes a partition 20 and a boot record 32. The partition 20 includes sub-partitions 22, 24, 26 and 28. Each sub-partition 22, 24, 26 and 28 is thus a logical partition of the partition 20. Each of the sub-partitions 22, 24, 26 and 28 can be a boot source. The boot record 32 includes data relating to the partition 20 and defines the sub-partitions 22, 24 26 and 28. The computer system 10 might also have other boot devices (not shown in FIG. 1). These boot devices might be accessed by a user only with a password.

The partition 20 is nonviewable from the operating system 12. In addition, the partition 20 is lockable from the operating system 12. The operating system 12 can thus be locked out from making changes to the partition 20. However, the partition 20 is available during pre-boot. The partition 20 is thus a PARTIES partition. The sub-partitions 22, 24, 26 and 28 in the partition 20 are boot sources for the computer system 10. Each sub-partition 22, 24, 26 or 28 may be different. Thus, each sub-partition 22, 24, 26 and 28 may provide 20 the user with different utilities for accessing different functions of and different portion within the computer system 10 once the computer system 10 has been booted from the sub-partition 22, 24, 26 and 28.

### COULD YOU TELL ME WHAT THE ACRONYM PARTIES STANDS FOR?

FIG. 2 depicts a conventional method 50 for using a sub-partition of a lockable, nonviewable partition as a boot source. The method 50 is described in conjunction with the computer system 10. Referring to FIGS. 1 and 2, the method 50 may be carried out upon start-up of the computer system 10, using the basic input output system (BIOS) of the computer system 10 (not shown in FIG. 1). The hardfile 30 is accessed, via step 52. Step 52 could include using the BIOS to read the boot record 32 and determine the identity of the partition 20 and the sub-partitions 22, 24, 26 and 28. The user is queried as to which sub-partitions 22, 24, 26 and 28 to use in booting the computer system 10, via step 54. The user then selects one of the sub-partitions 22, 24, 26 and 28 to be the boot source for the computer system 10, via step 56. The use can select any one of the sub-partitions 22, 24, 26 and 28 as the boot source in step 56. The computer system 10 then boots from the selected sub-partition 22, 24, 26 or 28, via step 58. Thus, the computer system 10 can boot from a particular sub-partition 22, 24, 26 or 28.

Although the method 50 and computer system 10 function, one of ordinary skill in the art will readily recognize that the method 50 and computer system 10 are subject to attack and inadvertent misuse of utilities in some of the sub-partitions 22, 24, 26 and 28. Each sub-partition 22, 24, 26 and 28 may be used as a boot source by any user of the computer system 10. As a result, any user of the partition 20 can make use of the utilities made available through any of the sub-partitions 22, 24, 26 and 28. Some of the utilities may provide access to functions that should be restricted. For example, one of the sub-partitions 22, 24, 26 and 28 may have utilities that allow a user to reconfigure portions of the computer system 10 or destroy much is what of is in the memory (not explicitly shown) of the computer system 10. It may be desirable for only certain individuals, such as the network administrator or, in a family's computer, an adult, to have access to these utilities. It would be desirable, therefore, to ensure that at least some of the sub-partitions 22, 24, 26 and 28 are secure. In other words, it would be desirable to allow at least some of the sub-partitions 22, 24, 26 and 28 to be trusted boot sources. At the same time, other sub-partitions 22, 24, 26 or 28 may include utilities that all users can employ. Thus, relatively unrestricted access to some of these sub-partitions 22, 24, 26 and 28 is still desired.

Accordingly, what is needed is a system and method for providing more secure boot sources in a lockable, nonviewable partition such as the PARTIES partition. The present invention addresses such a need.

### SUMMARY OF THE INVENTION

The present invention provides a method and system for providing a trusted boot source in a computer system. The computer system includes an operating system and a partition that is nonviewable from the operating system. The method and system comprise allowing a plurality of sub-partitions to be defined in the partition. The plurality of sub-partitions corresponds to a plurality of boot sources. The method and system also comprise allowing a password to be provided for each of the plurality of sub-partitions. The password is required for a user to utilize a corresponding sub-partition as a boot source.

According to the system and method disclosed herein, the present invention provides a more secure set of boot sources for the computer system. The boot sources allow different users access to different portions of the computer system to ensure that portions of the computer system remain secure.

### BRIEF DESCRIPTION OF THE DRAWINGS

FIG. 1 is a block diagram of a conventional computer system.

FIG. 2 is a flow chart depicting a conventional method for booting using a sub-partition in a partition that is nonviewable from the operating system.

FIG. 3 is a block diagram depicting one embodiment of a computer system in accordance with the present invention that provides a trusted boot source through a partition that is nonviewable and preferably lockable from the operating system.

FIG. 4 is a high-level flow chart depicting one embodiment of a method in accordance with the present invention for providing trusted boot sources through a partition that is nonviewable and preferably lockable from from the operating system.

FIG. 5 is a more detailed flow chart of one embodiment of a method in accordance with the present invention for providing trusted boot sources through a partition that is nonviewable and preferably lockable from from the operating system.

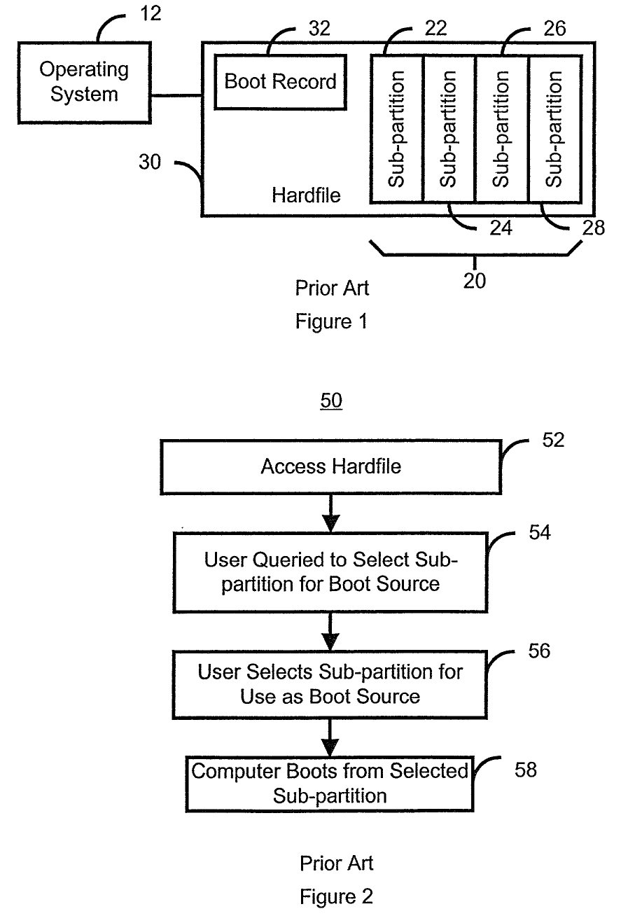

### DETAILED DESCRIPTION OF THE INVENTION

The present invention relates to an improvement in computer systems. The following description is presented to enable one of ordinary skill in the art to make and use the invention and is provided in the context of a patent application and its requirements. Various modifications to the preferred embodiment will be readily apparent to those skilled in the art and the generic principles herein may be applied to other embodiments. Thus, the present invention is not intended to be limited to the embodiment shown, but is to be accorded the widest scope consistent with the principles and features described herein.

The present invention provides a method and system for providing a trusted boot source in a computer system. The computer system includes an operating system and a partition that is nonviewable from the operating system. The method and system comprise allowing a plurality of sub-partitions to be defined in the partition. The plurality of sub-partitions corresponds to a plurality of boot sources. The method and system also comprise allowing a password to be provided for each of the plurality of sub-partitions. The password is required for a user to utilize a corresponding sub-partition as a boot source.

The present invention will be described in terms of a particular computer system and a partition having a particular number of sub-partitions. However, one of ordinary skill in the art will readily recognize that this method and system will operate effectively for other computer system and other partitions having a different number of sub-partitions. Furthermore, for clarity, only certain portions of the computer system are depicted. However, nothing prevents the use of other additional components in the computer system.

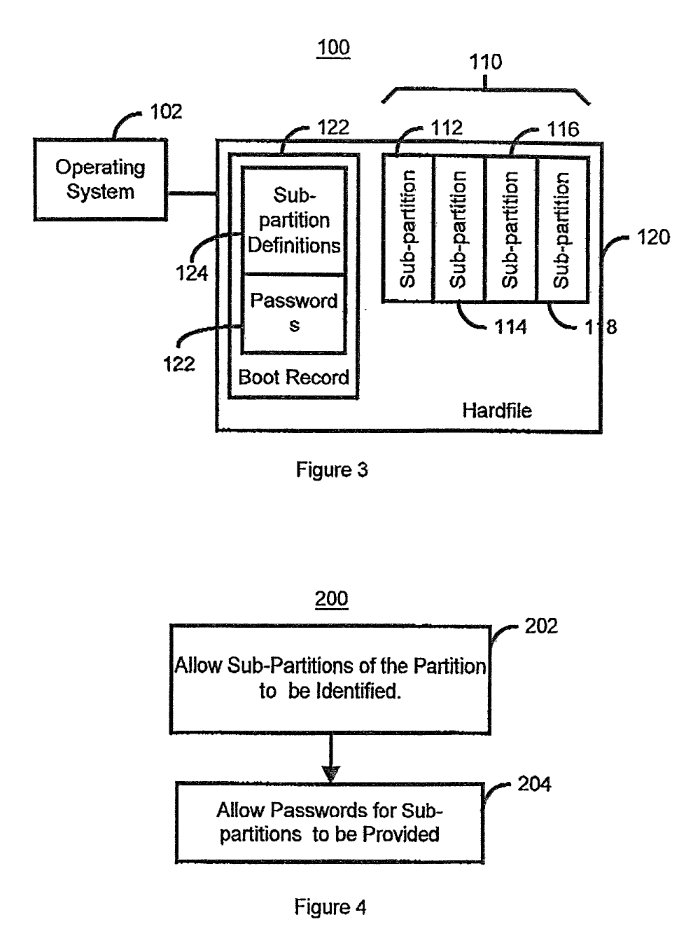

To more particularly illustrate the method and system in accordance with the present invention, refer now to FIG. 3, depicting one embodiment of a computer system 100 in accordance with the present invention. The computer system 100 includes an operating system 102 and a hardfile 120. The hardfile 120 includes a partition 110 and a boot record 122. The partition 110 is preferably nonviewable and lockable from the operating system 102. In a preferred embodiment, the partition 110 is also accessible during preboot. The partition 110 is preferably a PARTIES partition. The partition 110 includes sub-partitions 112, 114, 116 and 118. Although four sub-partitions 112, 114, 116 and 118 are shown, nothing prevents the use of another number of sub-partitions. Each of the sub-partitions 112, 114, 116 and 118 can be used as a boot source for the computer system 100. In a preferred embodiment, each of the sub-partitions makes available different utilities when used to boot the computer system 100. The boot record 122 preferably includes data relating to the partition 110 and defines the sub-partitions 112, 114, 116 and 118. Thus, the boot record includes definitions 124 of the sub-partitions 112, 114, 116 and 118 as well as a password list 126 that lists the passwords corresponding to each of the sub-partitions 112, 114, 116 and 118. The boot record 122 is preferably stored in a nonvolatile memory (not explicitly shown) of the computer system 100. As described below, the sub-partitions 112, 114, 116 and 118 are protected with individual passwords stored in the boot record 122. Thus, the sub-partitions 112, 114, 116 and 118 can each be a trusted boot source.

FIG. 4 depicts a high-level flow chart of a method 200 in accordance with the present invention for providing a trusted boot source. The plurality of sub-partitions 112, 114, 116 and 118 in the partition 110 are identified, via step 202. In addition to being identified, the sub-partitions 112, 114, 116 and 118 are preferably provided with the utilities desired for the computer system 100 in step 202. In a preferred embodiment, each of the sub-partitions 112, 114, 116 and 118 have different utilities for the computer system 100. Thus, each of the sub-partitions 112, 114, 116 and 118 allow a user who boots the computer system 100 a different level of freedom in utilizing and reconfiguring the computer system 100. A password for each of the sub-partitions 112, 114, 116 and 118 is provided, via step 204. The password for a sub-partition 112, 114, 116 or 118 is required for a user to utilize the sub-partition 112, 114, 116 or 118 to boot the computer system 100.

Because the sub-partitions 112, 114, 116 and 118 are each protected by a password, access can be restricted to users having the corresponding password. As a result, the sub-partitions 112, 114, 116 and 118 can be trusted boot sources for the computer system. Not every user having access to the partition 110 can boot using all sub-partition 112, 114, 116 and 118. Instead, a user can be given a password for sub-partitions 112, 114, 116 or 118 that correspond to the user's level of security. For example, a system administrator may have the password for all sub-partitions 112, 114, 116 and 118, including those that allow the computer system 100 to be reconfigured. A user of the computer system 100 may, however, be provided with a password to one or two of the sub-partitions 112, 114, 116 and 118. Thus, the user can still boot the computer system 100 using the partition 110, but may not be able to reconfigure the computer system 100. Thus, secure boot sources can be provided for the computer system 100 in the partition 100, while allowing users having lower level security clearance access to one or more of the sub-partitions 112, 114, 116 and 118.

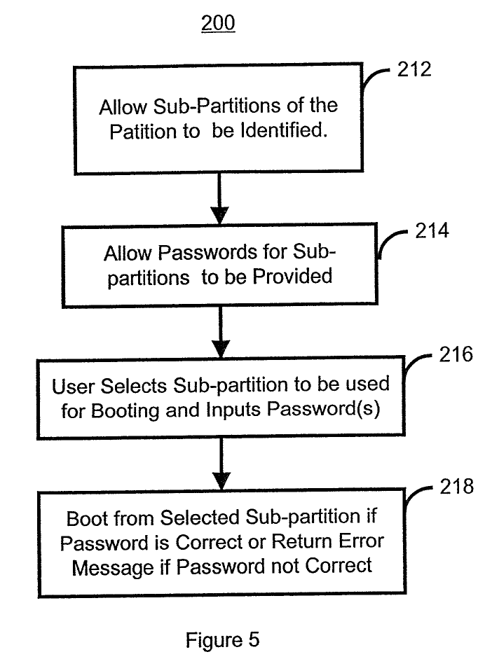

FIG. 5 depicts a more detailed flow chart of a method 210 for providing a trusted boot source. The method 210 is preferably used in conjunction with the computer system 100. Consequently, the method 210 will be described in the context of the computer system 100. Referring to FIGS. 3 and 5, the plurality of sub-partitions 112, 114, 116 and 118 in the partition 110 are identified, via step 212. Step 212 is analogous to the step 202 of the method 200 depicted in FIG. 4. Referring back to FIGS. 3 and 5, step 202 preferably provides the definitions 124 of the sub-partitions 112 114, 116 and 118. A password for each of the sub-partitions 112, 114, 116 and 118 is provided, via step 214. The password for a sub-partition 112, 114, 116 or 118 is required for a user to boot the computer system 100 using the sub-partition 112, 114, 116 or 118. In one embodiment, the passwords provided in step 214 could include an additional password for the partition 110. Thus, in one embodiment, a user will need two passwords, one for the partition 110 and one for the sub-partition 112, 114, 116 or 118 that the user will utilize in booting the computer system 100. The passwords provided in step 214 are preferably stored in the list 126 of the boot record 122.

When the computer system 100 is to be booted, the user inputs the desired sub-partition 112, 114, 116 and 118 to be used as a boot source and the password(s) needed to access the desired sub-partition 112, 114, 116 or 118, via step 216. Preferably, step 216 occurs when the BIOS (not shown) for the computer system 100 reads the boot record 122 and understands that one of the sub-partitions 112, 114, 116 or 118 can be selected as a boot source for the computer system 100. Also in a preferred embodiment, the computer system 100 will query the user for the desired sub-partition 112, 114, 116 or 118 to be used as a boot source, then query the user for the password for the sub-partition 112, 114, 116 or 118 that was selected. A user may input multiple passwords in step 216. For example, a user might provide a first password to access the partition 110, select a sub-partition 112, 114, 116 or 118 as a boot source, then input a second password to utilize one of the sub-partitions 112, 114, 116 or 118 as a boot source. If the sub-partition to be used as a boot source has been selected and the password provided, the computer system 100 will boot off of the selected sub-partition, via step 218. If the correct password has not been provided, then the computer system 100 will return an error message in step 218.

Thus, the method 210 allows a user to boot from one of the sub-partitions 112, 114, 116 or 118 if the user provides the corresponding password. Because each of the sub-partitions 112, 114, 116 and 118 can be protected by a password, the sub-partitions 112, 114, 116 and 118 can be trusted boot sources for the computer system. Not every user having access to the partition 110 can boot using all sub-partition 112, 114, 116 and 118. Instead, a user can boot using the sub-partitions 112, 114, 116 or 118 and have access to the utilities provided through the sub-partitions 112, 114, 116 and 118 only if the user has the corresponding password. Thus, certain utilities can be restricted for use by some users. For example, a system administrator may have the password for all sub-partitions 112, 114, 116 and 118, including those that allow the computer system 100 to be reconfigured. Other users of the computer system 100 may, however, be provided with a password to one of the sub-partitions 112, 114, 116 and 118 that does not provide the utilities for reconfiguring the computer system 100. The user can still boot the computer system 100, but may not be able to reconfigure the computer system 100. Thus, secure boot sources can be provided for the computer system 100 in the partition 100, while allowing users having lower level security clearance access to one or more of the sub-partitions 112, 114, 116 and 118.

A method and system has been disclosed for providing a trusted boot source from a partition. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary

What is claimed is:

1. A method for providing a trusted boot source in a computer system, the computer system including a partition and an operating system, the partition being nonviewable from the operating system, the method comprising the steps of:
(a) allowing a plurality of sub-partitions to be defined in the partition, the plurality of sub-partitions corresponding to a plurality of boot sources; and
(b) allowing a password to be provided for each of the plurality of sub-partitions, the password being required for a user to utilize a corresponding sub-partition as a boot source.

2. The method of claim 1 further comprising the step of:
(c) allowing a user to boot from a sub-partition of the plurality sub-partitions if the user provides the password for the sub-partition.

3. The method of claim 1 wherein the partition is stored in a hardfile of the computer system.

4. The method of claim 3 wherein an identity of each of the plurality of sub-partitions and the password for each sub-partition is stored in the hardfile.

5. The method of claim 1 wherein the partition is lockable from the operating system.

6. A computer system comprising:
an operating system;
a partition including a plurality of sub-partitions, the partition being nonviewable from the operating system, the plurality of sub-partitions corresponding to a plurality of boot sources; and
a password for each of the plurality of sub-partitions, the password being required for a user to utilize a corresponding sub-partition as a boot source.

7. The computer system of claim 6 wherein a user is allowed to boot from a sub-partition of the plurality sub-partitions if the user provides the password for the sub-partition.

8. The computer system of claim 6 wherein the computer system further includes a hardfile and wherein the partition is stored in the hardfile.

9. The computer system of claim 8 wherein an identity of each of the plurality of sub-partitions and the password for each sub-partition is stored in the hardfile.

10. The computer system of claim 6 wherein the partition is lockable from the operating system.
